(19) United States
(12) Patent Application Publication
(10) Pub. No.: US 2020/0385173 A1
(43) Pub. Date: Dec. 10, 2020

(54) Multi-Handle Trashcan Apparatus

(71) Applicant: Joey Hudson, O-Fallon, IL (US)

(72) Inventor: Joey Hudson, O-Fallon, IL (US)

(21) Appl. No.: 16/436,335

(22) Filed: Jun. 10, 2019

(51) Int. Cl. B65D 25/28; B65F 1/12

(52) U.S. Cl. CPC B65D 25/2808; B65F 1/1473; B65F 1/12

(57) ABSTRACT

A multi-handle trashcan apparatus for easier lifting and dumping includes a can body having a bottom side, a sidewall, and an open top side. A rim is coupled to the sidewall adjacent the open top side. The rim has a pair of channels extending through to the sidewall. A lip is coupled around a perimeter of the open top side of the can body. A pair of top handles is coupled to the rim. Each of the top handles extends between a pair of inner walls of each of the pair of channels. A pair of lower handles is coupled to the sidewall of the can body proximal the bottom side.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to trashcans and more particularly pertains to a new trashcan for easier lifting and dumping.

### BRIEF SUMMARY OF THE INVENTION

An embodiment of the disclosure meets the needs presented above by generally comprising a can body having a bottom side, a sidewall, and an open top side. A rim is coupled to the sidewall adjacent the open top side. The rim has a pair of channels extending through to the sidewall. A lip is coupled around a perimeter of the open top side of the can body. A pair of top handles is coupled to the rim. Each of the top handles extends between a pair of inner walls of each of the pair of channels. A pair of lower handles is coupled to the sidewall of the can body proximal the bottom side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a multi-handle trashcan apparatus according to an embodiment of the disclosure.

FIG. 2 is a front elevation view of an embodiment of the disclosure.

FIG. 3 is a side elevation view of an embodiment of the disclosure.

FIG. 4 is a top plan view of an embodiment of the disclosure.

FIG. 5 is a bottom plan view of an embodiment of the disclosure.

FIG. 6 is an in-use view of an embodiment of the disclosure.

### DETAILED DESCRIPTION OF THE INVENTION

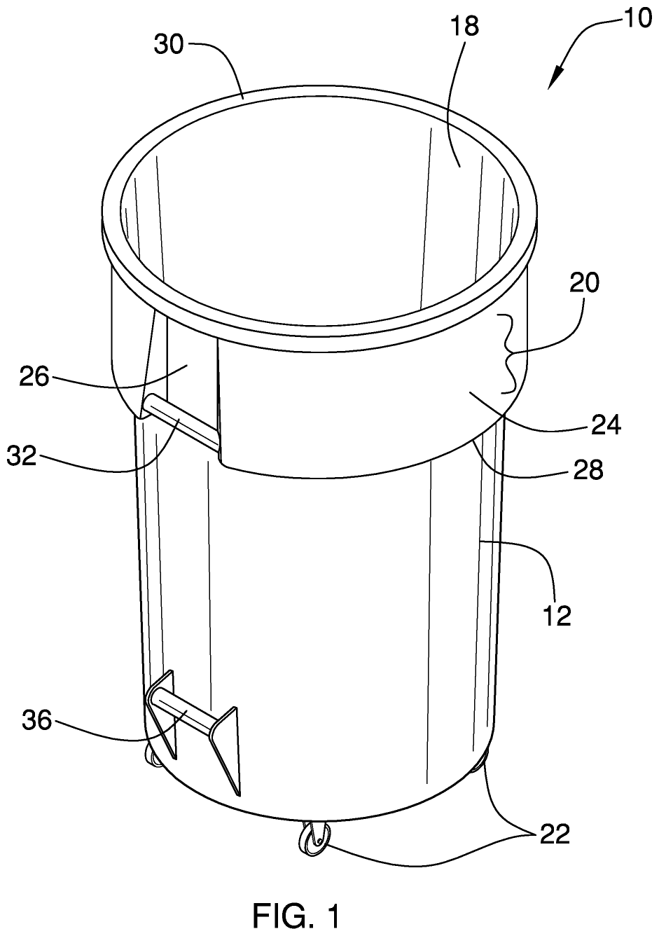

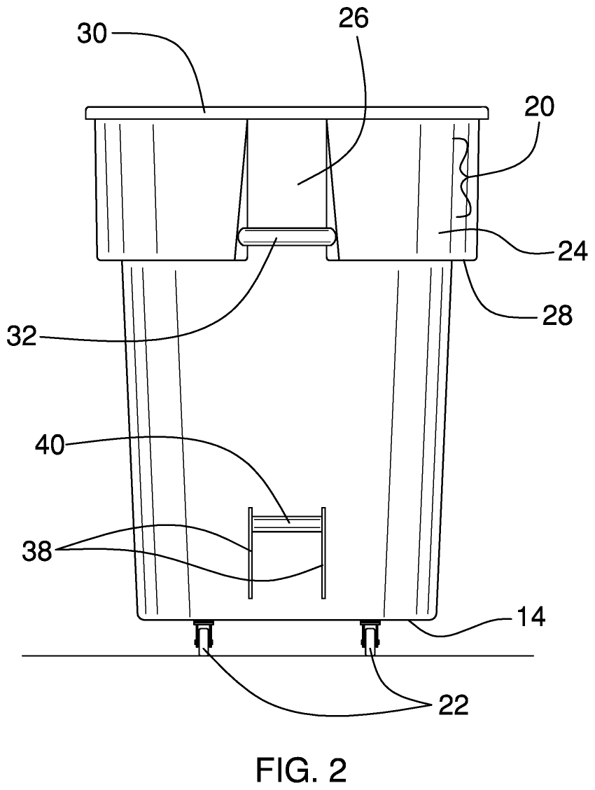

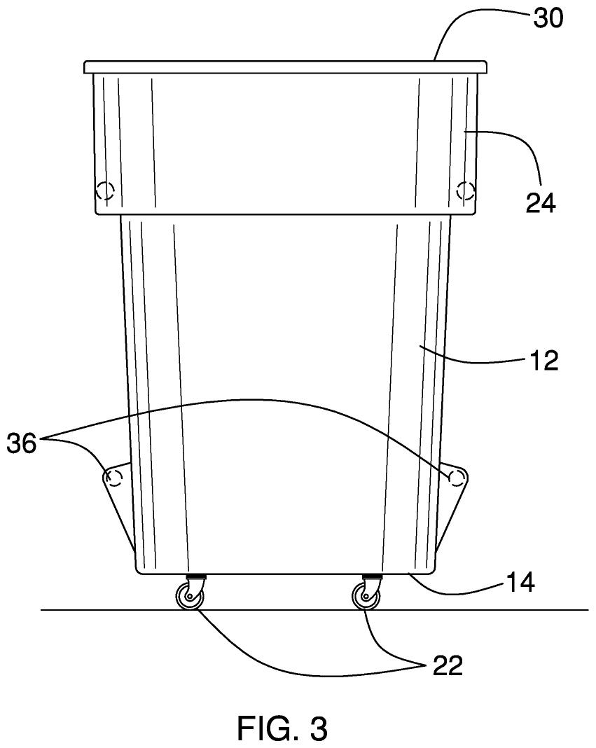

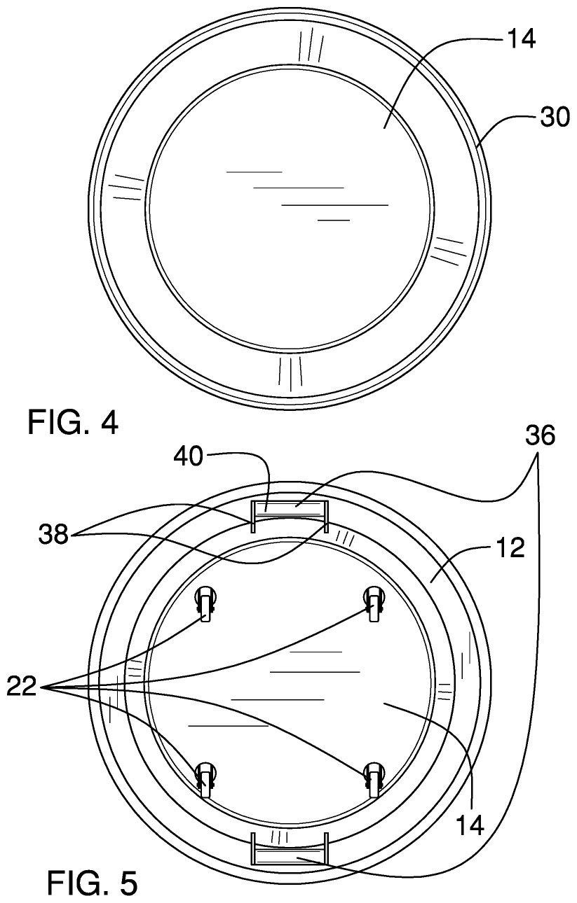

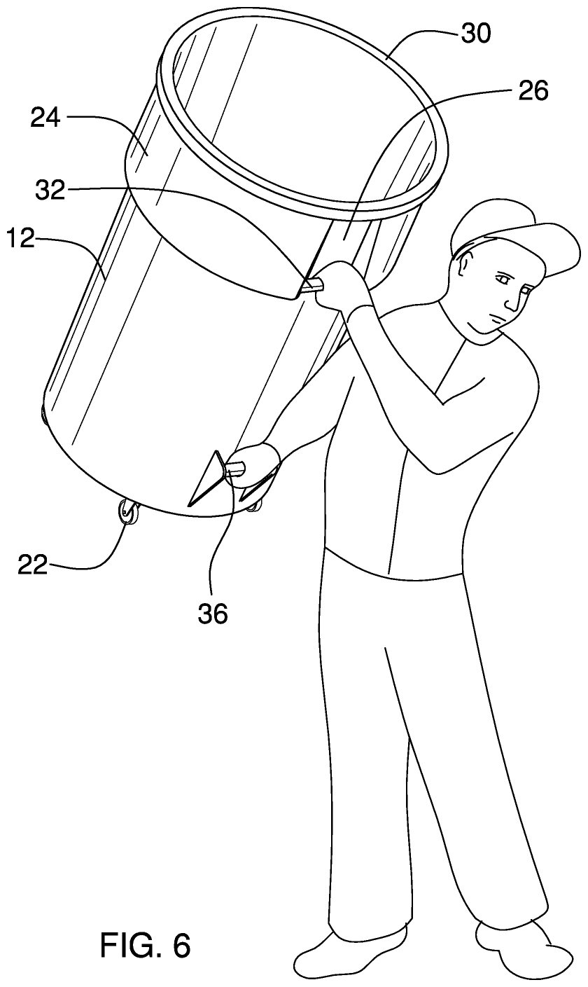

With reference now to the drawings, and in particular to FIGS. 1 through 6 thereof, a new trashcan embodying the principles and concepts of an embodiment of the disclosure and generally designated by the reference numeral 10 will be described.

As best illustrated in FIGS. 1 through 6, the multi-handle trashcan apparatus 10 generally comprises a can body 12 having a bottom side 14, a sidewall 16, and an open top side 18. The sidewall 16 tapers from the open top side 18 towards the bottom side 14 and may be either cylindrical or cuboidal. A plurality of wheels 22 is coupled to the bottom side 14 of the can body. The plurality of wheels 22 may be a set of four swivelable wheels 22 arranged in a square layout to evenly distribute weight and allow the apparatus 10 to be spun and rolled in any direction. A rim 24 is coupled to the sidewall 16 of the can body adjacent the open top side 18. The rim 24 covers between 20% and 30% of the sidewall 16. An outer face 20 of the rim is vertical when the apparatus 10 rests on the bottom side 14. The rim 24 has a pair of channels 26 extending through to the sidewall 16 from the open top side 18 to a bottom edge 28 of the rim 24. Each of the pair of channels 26 is arranged 180° apart around the sidewall 16. A lip 30 is coupled to the can body 12 around a perimeter of the open top side 18.

A pair of top handles 32 is coupled to the rim 24. Each of the top handles 32 extends between a pair of triangular inner walls 34 of each of the pair of channels 26. A width of each channel 26, and thus a length of each top handle 32, is configured to comfortably accommodate a user's hand wearing a work glove. A pair of lower handles 36 is coupled to the sidewall 16 of the can body proximal the bottom side 14. The lower handles 36 are arranged 180° apart and align with the top handles 32. Each of the lower handles 36 comprises a pair of triangular supports 38 each perpendicularly coupled to the sidewall 16 and a grip bar 40 extending between the pair of supports 38. Each grip bar 40 and each top handle 32 lies along parallel axes. A width between the pair of supports 38, and thus a length of each grip bar 40, substantially conforms to the length of each top handle 32.

In use, the apparatus 10 may be lifted by the pair of top handles 32 or by one top handle 32 and the lower handle 36 on the same side. When dumping contents from the apparatus 10 both lower handles 36 may be secured simultaneously.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multi-handle trashcan apparatus comprising:
a can body, the can body having a bottom side, a sidewall, and an open top side;
a rim coupled to the can body, the rim being coupled the sidewall adjacent the open top side, the rim having a pair of channels extending through to the sidewall;
a lip coupled to the can body, the lip being coupled around a perimeter of the open top side;
a pair of top handles coupled to the rim, each of the top handles extending between a pair of inner walls of each of the pair of channels; and
a pair of lower handles coupled to the can body, the pair of lower handles being coupled to the sidewall proximal the bottom side.

2. The multi-handle trashcan apparatus of claim 1 further comprising a plurality of wheels being coupled to the can body, the plurality of wheels being coupled to the bottom side.

3. The multi-handle trashcan apparatus of claim 1 further comprising the plurality of wheels being a set of four swivelable wheels arranged in a square layout.

4. The multi-handle trashcan apparatus of claim 1 further comprising the rim covering between 20% and 30% of the sidewall.

5. The multi-handle trashcan apparatus of claim 1 further comprising the sidewall tapering from the open top side towards the bottom side, an outer face of the rim being vertical, the inner walls being triangular.

6. The multi-handle trashcan apparatus of claim 1 further comprising the pair of channels of the rim being 180° apart.

7. The multi-handle trashcan apparatus of claim 6 further comprising the pair of lower handles being 180° apart, the lower handles aligning with the top handles.

8. The multi-handle trashcan apparatus of claim 1 further comprising each of the lower handles comprising a pair of supports each perpendicularly coupled to the sidewall and a grip bar extending between the pair of supports.

9. The multi-handle trashcan apparatus of claim 8 further comprising each of the pair of supports being triangular.

10. The multi-handle trashcan apparatus of claim 8 further comprising the grip bar of each of the lower handles and the pair of top handles lying along parallel axes.

11. The multi-handle trashcan apparatus of claim 1 further comprising the can body being cylindrical.

12. The multi-handle trashcan apparatus of claim 1 further comprising the can body being cuboidal.

13. A multi-handle trashcan apparatus comprising:
a can body, the can body having a bottom side, a sidewall, and an open top side, the sidewall tapering from the open top side towards the bottom side, an outer face of the rim being vertical;
a plurality of wheels being coupled to the can body, the plurality of wheels being coupled to the bottom side, the plurality of wheels being a set of four swivelable wheels arranged in a square layout;
a rim coupled to the can body, the rim being coupled the sidewall adjacent the open top side, the rim covering between 20% and 30% of the sidewall, the rim having a pair of channels extending through to the sidewall, the pair of channels being 180° apart;
a lip coupled to the can body, the lip being coupled around a perimeter of the open top side;
a pair of top handles coupled to the rim, each of the top handles extending between a pair of triangular inner walls of each of the pair of channels; and
a pair of lower handles coupled to the can body, the pair of lower handles being coupled to the sidewall proximal the bottom side, the lower handles being 180° apart and aligning with the top handles, each of the lower handles comprising a pair of triangular supports each perpendicularly coupled to the sidewall and a grip bar extending between the pair of supports, each grip bar and the pair of top handles lying along parallel axes.
